(19) United States
(12) Patent Application Publication
(10) Pub. No.: US 2011/0163965 A1
(43) Pub. Date: Jul. 7, 2011

(54) TOUCH PANEL AND DETECTING METHOD FOR MULTIPLE-TOUCHING OF THE SAME, AND TOUCH DISPLAY APPARATUS

(75) Inventors: Chao-Yong Hsu, Changhua County (TW); Shih-Hung Huang, Taoyuan County (TW); Shin-Chung Huang, Taipei County (TW); Yi-Nan Chu, Changhua County (TW)

(73) Assignee: CHUNGHWA PICTURE TUBES, LTD., Taoyuan (TW)

(21) Appl. No.: 12/757,056

(22) Filed: Apr. 9, 2010

(30) Foreign Application Priority Data
Jan. 6, 2010 (TW) 99100177

(51) Int. Cl. G06F 3/041

(52) U.S. Cl. 345/173

(57) ABSTRACT

A touch panel including a substrate, a sensing array and a signal detecting layer is provided. The sensing array disposed over the substrate comprises a plurality of sensing pads arranged in array, wherein the sensing pads includes a plurality of first sensing pads arranged along a first direction and a plurality of second sensing pads arranged along a second direction, and the first direction intersects the second direction. The signal detecting layer is interlaid between the sensing array and the substrate, wherein the signal detecting layer includes a plurality of individual signal detecting units. Each of the signal detecting units is corresponding to more than one sensing pads for detecting a variation of electric field due to a touching event. By which, erroneous sensing of the touch panel can be prevented. Furthermore, a detecting method for multiple-touching applied to the touch panel and a touch display apparatus are provided.

### CROSS-REFERENCE TO RELATED APPLICATION

This application claims the priority benefit of Taiwan application serial no. 99100177, filed on Jan. 6, 2010. The entirety of the above-mentioned patent application is hereby incorporated by reference herein and made a part of specification.

### BACKGROUND OF THE INVENTION

1. Field of the Invention

The present invention relates to a touch detecting device and a detecting method thereof, and more particularly, to a touch panel and a detecting method for multiple touching by applying the touch panel.

2. Description of Related Art

Information technologies (ITs), wireless mobile communications, and information home appliances have been rapidly developed and widely applied in recent years. To meet current demands on portable, compact, and user-friendly IT products, touch panels have been introduced as input devices in replacement of conventional input devices, such as keyboards or mice.

FIG. 1 shows a convention touch panel, wherein only the structure of sensing series of the touch panel is presented in FIG. 1, while other probable layers or elements are omitted for a clear illustration. Referring to FIG. 1, the touch panel 100 includes a plurality of first sensing series 120 and a plurality of second sensing series 140. Particularly, the first sensing series 120 extends along the Y-direction, wherein each of the first sensing series 120 is formed by serially connect a plurality of first sensing pads 122 and first connecting wires 124. The second sensing series 140 extends along the X-direction, wherein each of the second sensing series 140 is formed by serially connect a plurality of second sensing pads 142 and second connecting wires 144. The first sensing pads 122 and the second sensing pads 142 forms a sensing array to accomplish a plane sensing.

When a user touches the touch panel 100 via a finger, the first sensing series 120 and the second sensing series 140 produce a variation of capacitance at the touch location on the touch panel 100.

The variation of capacitance is transferred to a control signal and transmitted to a control circuit board, and then after evaluation, an instruction is outputted for operating an electronic device.

Referring to FIG. 1, waveforms of the signals obtained as the user touches both of a location A and a location B is presented. In the process of detecting the touching locations, a first sensing series 120 and the second sensing series 140 are respectively scanned along the X-direction and the Y-direction. Since the coupling of capacitance occurs on one of the first sensing series 120 and on one of the second sensing series 140 as the user touches the touch panel 100, the touch location can be located by integrating the locations of the peaks in the X-direction and the Y-direction.

However, as shown in FIG. 1, if the user touches both of the location A and the location B at the same time, two peaks X1 and X2 in the X-direction and two peaks Y1 and Y2 in the Y-direction are produced, and thereby four points A, B, A′ and B′ are obtained by integrating the locations of the peaks X1, X2, Y1 and Y2, wherein the two unreal touching points A′ and B′ named ghost points are also produced. Due to the two ghost points, the conventional detecting method for multiple-touching is incapable of distinguishing the unreal locations from the real one, and may lead to abnormal operations.

### SUMMARY OF THE INVENTION

The present invention is directed to a touch panel capable of verifying a touch signal on the sensing array by a signal detecting layer, so as to improve the precision of locating the touch location on the touch panel.

The present invention is further directed to a detecting method for multiple-touching, which is capable of eliminating the erroneous sensing point in multiple-touching.

The present invention is also directed to a touch display apparatus capable of verifying a touch signal on the sensing array by a signal detecting layer, so as to improve the precision of locating the touch location on the touch panel.

As embodied and broadly described herein, the present invention provides a touch panel including a substrate, a sensing array and a signal detecting layer. The sensing array disposed over the substrate comprises a plurality of sensing pads arranged in array, wherein the sensing pads includes a plurality of first sensing pads arranged along a first direction and a plurality of second sensing pads arranged along a second direction, and the first direction intersects the second direction. The signal detecting layer is interlaid between the sensing array and the substrate, wherein the signal detecting layer comprises a plurality of individual signal detecting units, and each of the signal detecting units is corresponding to more than one sensing pads for detecting a variation of electric field due to a touching event.

In an embodiment of the present invention, the touch panel further comprises a plurality of signal detecting wires, wherein each of the signal detecting wires is electrically connected to its corresponding signal detecting unit.

In an embodiment of the invention, the sensing array further comprises a plurality of first bridge wires and a plurality of second bridge wires, wherein each of the first bridge wires serially connects two adjacent first sensing pads to form a first sensing series, and each of the second bridge wires serially connects two adjacent second sensing pads to form a second sensing series.

In an embodiment of the invention, the first sensing pads, the second sensing pads and the second bridge wires are formed by a same transparent conductive layer, while the first bridge wires are formed by another conductive layer.

In an embodiment of the invention, the first sensing pads, the second sensing pads and the first bridge wires are formed by a same transparent conductive layer, while the second bridge wires are formed by another conductive layer.

In an embodiment of the invention, each of the signal detecting units is shaped in substantially a block, and an outline of each of the signal detecting units is aligned with the edge of its corresponding sensing pads.

In an embodiment of the invention, each of the signal detecting units is shaped in substantially a stripe, the signal detecting units are parallel to one another and each of signal detecting units is arranged along a third direction different from the first direction and the second direction, and an outline of each of the signal detecting units is aligned with the edge of its corresponding sensing pads.

In an embodiment of the invention, each of the signal detecting units comprises a plurality of signal detecting pads, each of the signal detecting pads is corresponding to one of the sensing pads, each of the signal detecting pads has an opening in a size substantially equal to a size of each of the sensing pads, and the signal detecting pads coincide with clearances between the sensing pads.

In an embodiment of the invention, each of the signal detecting units comprises a plurality of signal detecting pads, each of the signal detecting pads is corresponding to one of the sensing pads, each of the signal detecting pads is intact, and a size of each of the signal detecting pads is substantially equal to a size of each of the sensing pads.

In an embodiment of the invention, the touch panel further comprises a controller electrically connected to the signal detecting wires, wherein the variation of electric field due to the touching event detected by the signal detecting units is transmitted to the controller to determine whether a touch event occurs.

In an embodiment of the invention, the touch panel further comprises a dielectric layer interlaid between the sensing array and the signal detecting layer.

In an embodiment of the invention, the touch panel further comprises a display panel, wherein the substrate is located on the display panel, and the signal detecting layer is located between the display panel and the sensing array.

The present invention further provides a detecting method for multiple-touching applied to the aforementioned touch panel. The detecting method for multiple-touching including: obtaining a touching location according to a variation of capacitance of the sensing pads in the sensing array; determining whether a touching event occurs by the signal detecting units of the signal detecting layer according to a variation of electric field due to a touching event; and comparing the touch location obtained from the sensing array with the determination result from the signal detecting layer.

In an embodiment of the invention, the detecting method further comprises shielding an error sensing location according to a result of comparison.

In an embodiment of the invention, the detecting method further comprises obtaining a real sensing location according to a result of comparison.

The present invention further provides a touch display apparatus including a touch panel and a display panel. The touch panel includes a substrate, a sensing array and a signal detecting layer. The sensing array disposed over the substrate comprises a plurality of sensing pads arranged in array, wherein the sensing pads includes a plurality of first sensing pads arranged along a first direction and a plurality of second sensing pads arranged along a second direction, and the first direction intersects the second direction. The signal detecting layer is interlaid between the sensing array and the substrate, wherein the signal detecting layer comprises a plurality of individual signal detecting units, and each of the signal detecting units is corresponding to more than one sensing pads for detecting a variation of electric field due to a touching event. The display panel is disposed relative to the touch panel, wherein the signal detecting layer is located between the display panel and the sensing array.

Based on the above, the present invention provides a touch panel, a detecting method for multiple touching applied to the touch panel and a touch display apparatus, wherein a signal detecting layer comprising plural signal detecting units is provided to detect the variation of electric field due to a touching event, and thereby the real touch location can be determined. Accordingly, the ghost point produced by multiple-touching on the touch panel can be eliminated, which facilitates an accurate evaluation of the real touch location and improve the precision of locating the touch location on the touch panel.

To make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 show a conventional touch panel.

FIG. 2A is a schematic view of a touch panel according to an embodiment of the present invention, while FIG. 2B is a cross-sectional view of the touch panel in FIG. 2A.

FIG. 2C is a schematic top view of the touch panel in FIG. 2A.

FIG. 2D is a cross-sectional view of a touch display apparatus according to an embodiment of the present invention.

FIG. 3 is a schematic top view of the signal detecting layer of the touch panel in FIG. 2A.

FIG. 4 is a schematic top view of the signal detecting layer according to an embodiment of the present invention.

FIG. 5 is a schematic top view of the signal detecting layer according to an embodiment of the present invention.

FIG. 6 is a schematic top view of the signal detecting layer according to an embodiment of the present invention.

FIG. 7 shows flowcharts illustrating a detecting method for multiple-touching applied to the touch panels of the present invention.

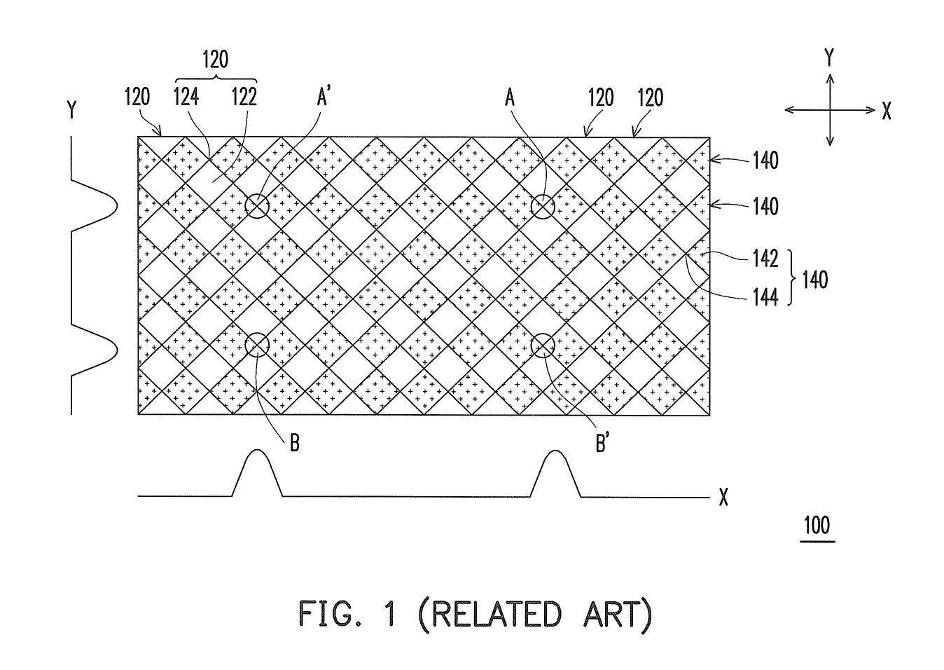

### DESCRIPTION OF EMBODIMENTS

The present invention provides a touch panel and a detecting method of multiple-touching applied on the same, wherein a signal detecting layer is disposed on the sensing array of the touch panel, and the signal detecting layer comprises a plurality of signal detecting units for detecting the variation of electric field due to a touching event, such that a real touching location can be determined by comparing the signal detected by the signal detecting layer and the touch point on the sensing array. Therefore, the determination precision of the touch panel can be dramatically improved, and thereby the ghost point on touch panel can be eliminated. Embodiments accompanying with drawings are provided in the following to illustrate the touch panel and the detecting method for multiple-touching applied to the touch panel.

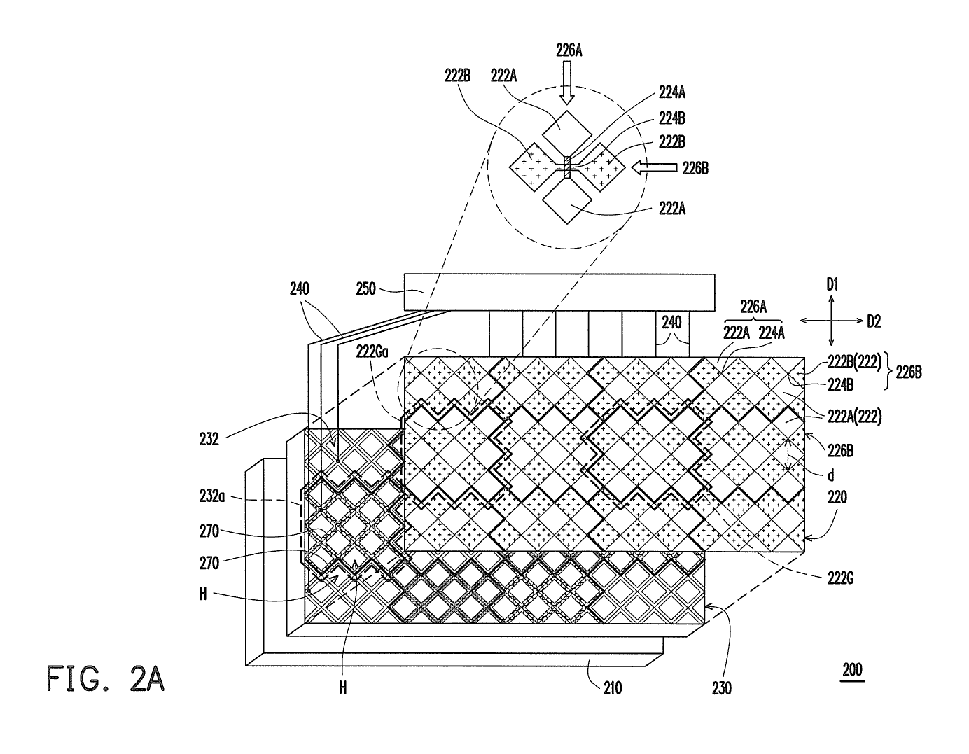

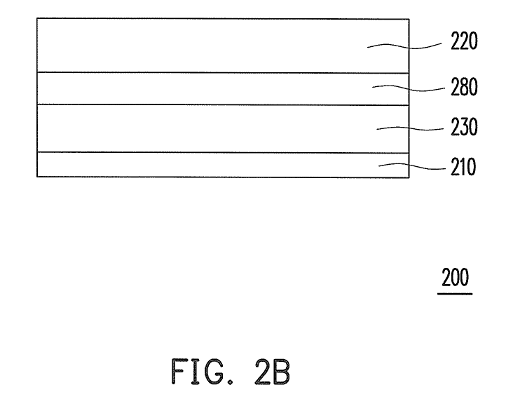

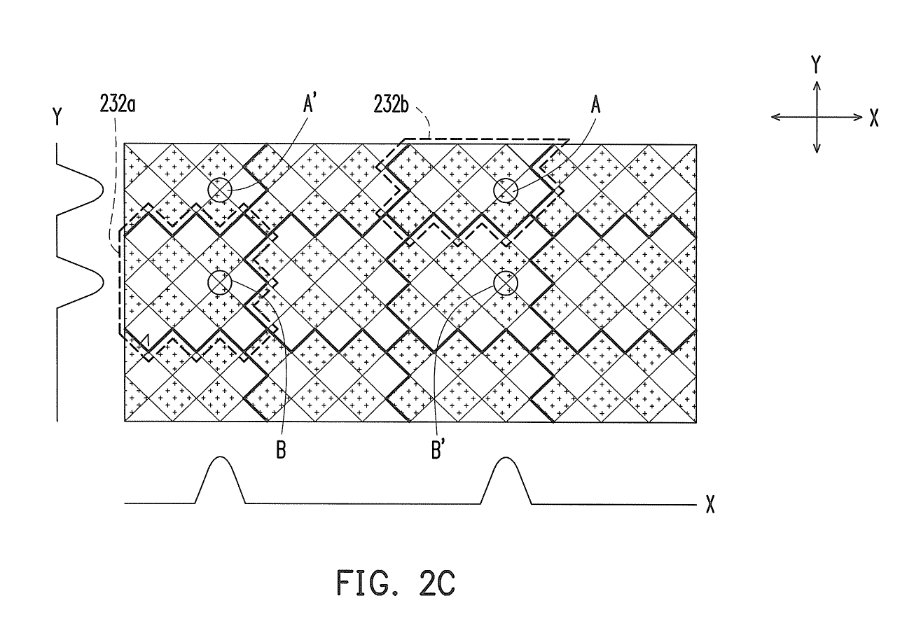

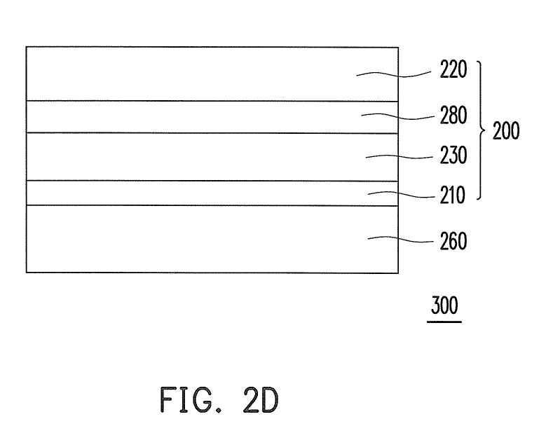

FIG. 2A is a schematic view of a touch panel according to an embodiment of the present invention, while FIG. 2B is a cross-sectional view of the touch panel in FIG. 2A. Referring to FIGS. 2A and 2B, the touch panel 200 includes a substrate 210, a sensing array 220 and a signal detecting layer 230. The sensing array 220 is disposed over the substrate 210, wherein the sensing array 220 comprises a plurality of sensing pads 222 arranged in array, to accomplish a plane sensing. The sensing pads 222 includes a plurality of first sensing pads 222A arranged along a first direction D1 and a plurality of second sensing pads 222B arranged along a second direction D2, and the first direction D1 intersects the second direction D2. In this embodiment, the first direction D1 is in column, and the second direction D2 is in row, wherein the first direction D1 is perpendicular to the second direction D2. However, the included angle between the first direction D1 and the second direction D2 is not limited to 90 degrees in other embodiments of the present invention, while the included angle may be varied to meet the requirements of product. Particularly, the signal detecting layer 230 is interlaid between the sensing array 220 and the substrate 210, wherein the signal detecting layer 230 comprises a plurality of individual signal detecting units 232, and each of the signal detecting units 232 is corresponding to the plural sensing pads 222 for detecting a variation of electric field due to the touching event. A structure of the touch panel 200 is described hereinafter.

Specifically, the sensing array 220 further comprises a plurality of first bridge wires 224A, wherein each of first bridge wires 224A sequentially connects two adjacent first sensing pads 222A to form a first sensing series 226A extending along a direction in column. On the touch panel 200, a plurality of first sensing series 226A are arranged side by side along a direction in row. In addition, the sensing array 220 further comprises a plurality of second bridge wires 224B, wherein each of second bridge wires 224B sequentially connects two adjacent second sensing pads 222B to form a second sensing series 226B extending along a direction in row. On the touch panel 200, a plurality of second sensing series 226B are arranged side by side along a direction in column. Furthermore, referring to the enlarged partial view in FIG. 2A, the first bridge wires 224A intersect the second bridge wires 224B. In the illustrated embodiment, the first sensing pads 222A, the second sensing pads 222B and the second bridge wires 224B are formed by a single transparent conductive layer, while the first bridge wires 224A are formed by another conductive layer. Although the first bridge wires 224A and the second bridge wires 224B are intersected with each other, they are still insulated by an insulation layer (not shown) interlaid therebetween so that the first bridge wires 224A and the second bridge wires 224B are electrically insulated from each other. Besides, one of ordinary skill in the art may change the constitution of the first sensing pads 222A, the second sensing pads 222B, the first bridge wires 224A and the second bridge wires 224B. For example, the first sensing pads 222A, the second sensing pads 222B and the first bridge wires 224A are formed by a single transparent conductive layer, while the second bridge wires 224B are formed by another conductive layer. Otherwise, the first bridge wires 224A and the second bridge wires 224B are respectively formed by two different conductive layers distinct from the first sensing pads 222A and the second sensing pads 222B. The first sensing pads 222A and the second sensing pads 222B can be made of a same conductive material or not. There provides no limitation on the positions and constitutions of the first sensing pads 222A, the second sensing pads 222B, the first bridge wires 224A and the second bridge wires 224B in the present application.

The first sensing pads 222A and the second sensing pads 222B are coplanar and form the sensing array 220 in a plane, for transmitting the variation of electric field at the location where a user touches to a controller.

Referring to FIGS. 2A and 2B, the touch panel 200 further comprises a plurality of signal detecting wires 240 and a controller 250, wherein each of the signal detecting wires 240 is electrically connected to its corresponding signal detecting unit 232, and the controller 250 is electrically connected to the signal detecting wires 240. For a clear illustration, FIGS. 2A and 2B schematically shows the electrical connection of each of the signal detecting wires 240 and its corresponding signal detecting unit 232. The layout of the signal detecting wires 240 can be regulated according to different requirements and may be located in the signal detecting units 232 or other applicable locations; in other words, the layout of the signal detecting wires 240 is not restricted to the illustrated layout shown in FIG. 2A. In addition, in this embodiment, a dielectric layer 280 is interlaid between the sensing array 220 and the signal detecting layer 230, such that the sensing array 220 and the signal detecting layer 230 are electrically insulated from each other by the dielectric layer 280. With respect to the operation mechanism, when the user touches the sensing array 220 and a variation of capacitance occurs at the touch location, a variation of electric field due to the touching event can be detected by the electric the signal detecting unit 232 corresponding to the touch location. Then, the sensing array 220 and the signal detecting layer 230 individually transmit a sensing signal and a signal of the variation of electric field to the controller 250. The controller 250 compares the sensing signal from the sensing array 220 and the signal of the variation of electric field from the signal detecting layer 230 to determine whether a touching event occurs.

FIG. 2C is a top view of the touch panel in FIG. 2A, wherein a contour of each of the signal detecting units 232 is shown. Referring to FIG. 2C, when the user touches a location A and a location B on the sensing array 220 at the same time, a variation of electric field at the locations A and B can be detected by the signal detecting units 232 corresponding thereto. Therefore, even though touch points may be determined at locations A, A′, B, and B′ by the sensing array 220 in the meanwhile, the signal of variation of electric field detected by the signal detecting layer 230, particularly by the signal detecting units 232a and 232b, can be used for a double check on the sensing signal of the sensing array 220. Since the locations A′ and B′ are not real touch points, there produces no variation of electric field at the locations A′ and B′, and thus the signal detecting units corresponding to locations A′ and B′ would not sense any variation of electric field. Accordingly, the detecting signal from the signal detecting layer 230 assists in determining the real touch points and solves the problem of ghost point in multiple-touching of the touch panel 200.

In a practical application, the touch panel is usually incorporated with a display panel to form a touch display apparatus. FIG. 2D is a cross-sectional view of a touch display apparatus according to an embodiment of the present invention. Referring to FIG. 2D, the substrate 210 of the touch panel 200 is located on the display panel 260 to form a touch display apparatus, wherein the signal detecting layer 230 is located between the display panel 260 and the sensing array 220. In some particular applications, the display panel 260 may further be electrically connected to the touch panel 200. In the touch display apparatus 300 of the embodiment, the display panel 260 can performs displaying functions according to the touch points detected by the touch panel 200. Therefore, as integrating the touch panel 200 with the display panel 260 to form the touch display apparatus, since the touch panel is capable of eliminating ghost points in multiple-touching of a conventional touch panel, the display panel 260 can correctly show a preferred frame for the user to prevent abnormal operation.

Details of the signal detecting layer 230 of the touch panel 200 as shown in FIG. 2A is further illustrated in the following.

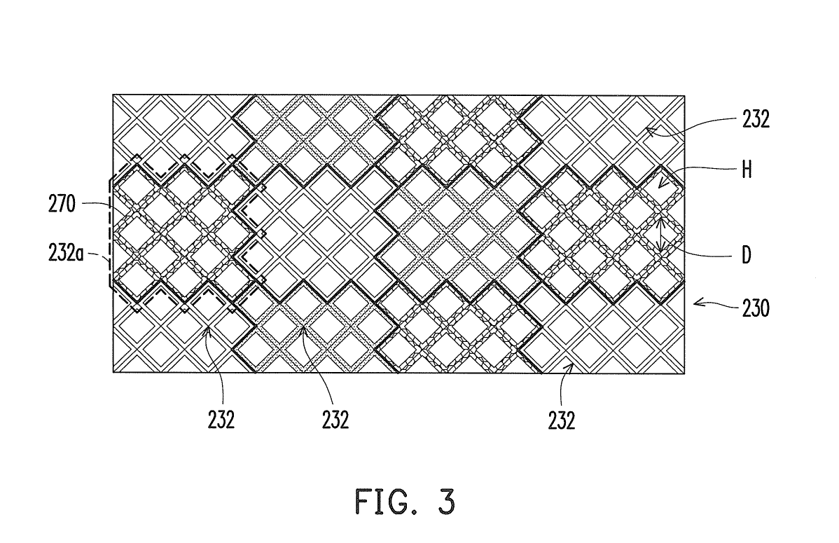

FIG. 3 is a schematic top view of the signal detecting layer of the touch panel in FIG. 2A. Referring to FIGS. 2A and 3, each of the signal detecting units 232 is shaped in substantially a block, wherein an outline of each of the signal detecting units 232 is aligned with the edge of its corresponding sensing pads 222. Specifically, the sensing array 220 is divided into a plurality sensing pad groups 222G, wherein each of the sensing pad groups is constituted by plural sensing pads 222 aggregating together. A portion of the signal detecting layer 230 located correspondingly below each of the sensing pad groups 222G is respectively defined as a signal detecting unit 232. Each of the signal detecting units 232 comprises a plurality of signal detecting pads 270, wherein each of the signal detecting pads 270 is corresponding to one of the sensing pad 222. For example, the signal detecting units 232a is corresponding to the sensing pad group 222Ga, the signal detecting unit 232a is shaped in substantially a block, and the outline of the signal detecting unit 232a substantially coincides with the edge of the outmost sensing pads 222 in the sensing pad group 222Ga.

Furthermore, referring to FIGS. 2A and 3, each of the signal detecting pads 270 has an opening H, wherein the size of the opening is approximately equal to the size of each of the sensing pads 222, and the signal detecting pad 270 substantially coincides with the clearance between the sensing pads 222. As shown in FIGS. 2A and 3, a diagonal length of the opening H of each of the signal detecting pads 270 is D, while a diagonal length of each of the sensing pads 222 is d. In the present embodiment, D is equal to d. In other words, the size of each of the signal detecting pads 270 is slightly larger than each of the sensing pads 222, such that the clearance between the sensing pads 222 exactly exposes the corresponding signal detecting pads 270. In other words, the sensing pads 222 are disposed directly above the corresponding openings H, such that a projection of the sensing pads 222 on the substrate 210 coincides with a projection of the openings H on the substrate 210. Therefore, the projection of the signal detecting pads 270 on the substrate 210 is located on the clearance between the sensing pads 222, and thereby the color shift between the lights passing through the sensing array 220 and the signal detecting layer 230 can be reduced to provide a superior vision effect. Additionally, since the signal detecting pads 270 are hollowed, the light transmittance rate of the entire touch panel 200 can be improved.

The operation of the controller 250 of FIG. 3 is similar to that mentioned in the above embodiments, and the details are not repeated herein.

Further another signal detecting layer of the present invention is illustrated in the following.

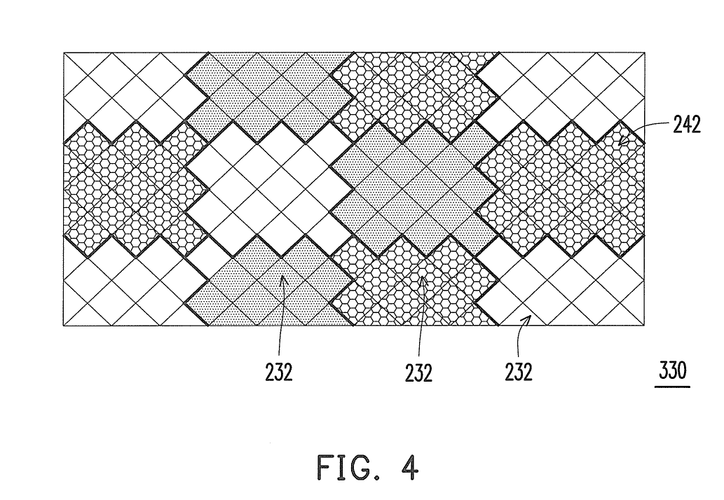

FIG. 4 is a schematic top view of the signal detecting layer according to an embodiment of the present invention. Referring to FIG. 4, the signal detecting layer 330 is almost similar to the signal detecting layer 230 as each of the signal detecting units 232 is shaped in substantially a block. However, in this embodiment, each of the signal detecting pads 270 is intact without being hollowed, and the size of each of the signal detecting pads 270 is substantially equal to the size of each of the sensing pads 222. When being incorporated with the display panel to form a touch display apparatus 300 as shown in FIG. 2D, the signal detecting layer 330 comprises the intact signal detecting pads 270 can serves as a signal shielding layer, which obstructs the interference from signals of the display panel 260 (as shown in 2D) to the touch panel 200 and thereby improves the sensitivity of the touch panel 200.

It is noted that the quantity and the shape of the signal detecting units 232 defined on the signal detecting layer 330 depends on the available space of the substrate, the quantity of leads of the controller, the resolution of sensing, the specifications of product or the like. The present invention provides no limitation on the shape and the quantity of the signal detecting units 232 of the signal detecting layer 330. One skilled in the art of the present invention can modify the shape and the deposition of the relevant devices without departing from the scope or spirit of the invention.

Another embodiment of the signal detecting layer of the present invention is further illustrated in the following.

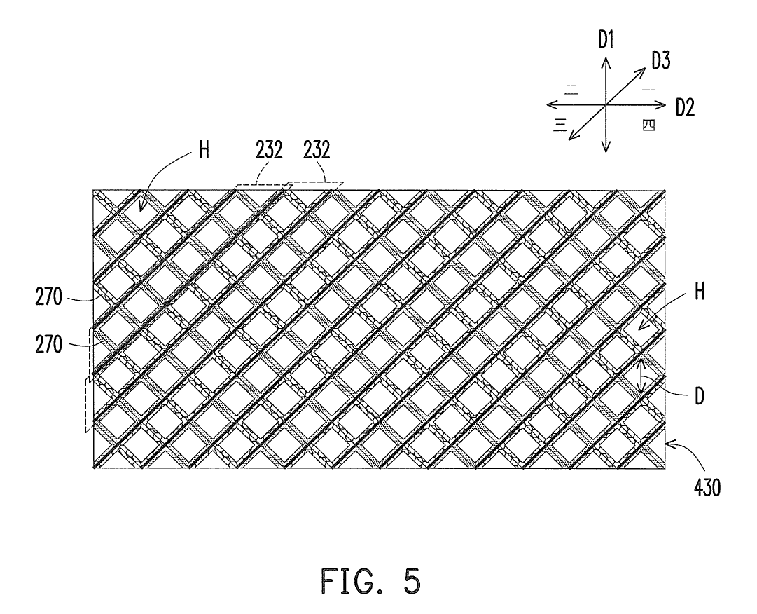

FIG. 5 is a schematic top view of the signal detecting layer according to an embodiment of the present invention. Referring to FIG. 5, each of the signal detecting units 232 of the signal detecting layer 430 is shaped in substantially a stripe. The signal detecting units 232 are parallel to one another and extend along a third direction D3 different from the first direction D1 and the second direction D2. In the present embodiment, the third direction D3 is extending from the first the first quadrant to the third quadrant. An outline of each of the signal detecting units 232 is aligned with the edge of the sensing pads 222 of the sensing array 220 in FIG. 2A. In this embodiment, the sensing array 220 is divided into a plurality of sensing pad groups 222G extending along the third direction D3 according to the stripe signal detecting units 232, wherein each of the sensing pad groups 222G is shaped in substantially a stripe in this embodiment rather than in substantially a block shown in FIG. 2A.

Furthermore, referring to FIGS. 2A and 5, each of the signal detecting pads 270 has an opening H, wherein the size D of the opening is approximately equal to the size d of each of the sensing pads 222, and the signal detecting pad 270 substantially coincides with the clearance between the sensing pads 222. In other words, the size of each of the signal detecting pads 270 is slightly larger than each of the sensing pads 222, such that the clearance between the sensing pads 222 exactly exposes the corresponding signal detecting pads 270. The sensing pads 222 are disposed directly above the corresponding openings H, such that a projection of the sensing pads 222 on the substrate 210 coincides with a projection of the openings H on the substrate 210. Therefore, the projection of the signal detecting pads 270 on the substrate 210 is located on the clearance between the sensing pads 222, and thereby the color shift between the lights passing through the sensing array 220 and the signal detecting layer 430 can be reduced to provide a superior vision effect. Additionally, since the signal detecting pads 270 are hollowed, the light transmittance rate of the entire touch panel 200 can be improved.

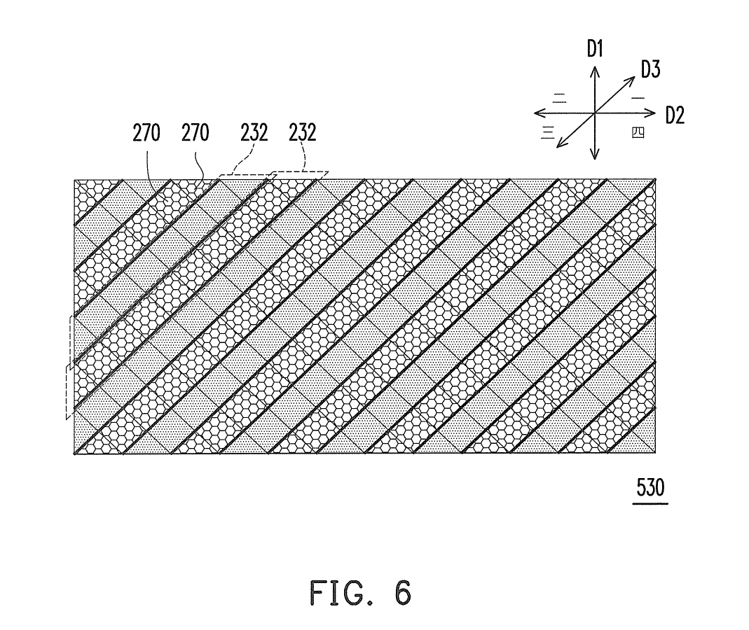

FIG. 6 is a schematic top view of the signal detecting layer according to an embodiment of the present invention. Referring to FIG. 6, the signal detecting layer 530 is almost similar to the signal detecting layer 430 as each of the signal detecting units 232 is shaped in substantially a stripe. However, in this embodiment, each of the signal detecting pads 270 is intact without being hollowed, and the size of each of the signal detecting pads 270 is substantially equal to the size of each of the sensing pads 222. Referring to FIGS. 6 and 2A, when being incorporated with the display panel 260 to form a touch display apparatus as shown in FIG. 2D, the signal detecting layer 530 comprises the intact signal detecting pads 270 can serves as a signal shielding layer, which obstructs the interference from signals of the display panel 260 to the touch panel 200 and thereby improves the sensitivity of the touch panel 200.

A detecting method for multiple-touching applied to a touch panel such as the touch panel 200 in FIG. 2A is illustrated in the following.

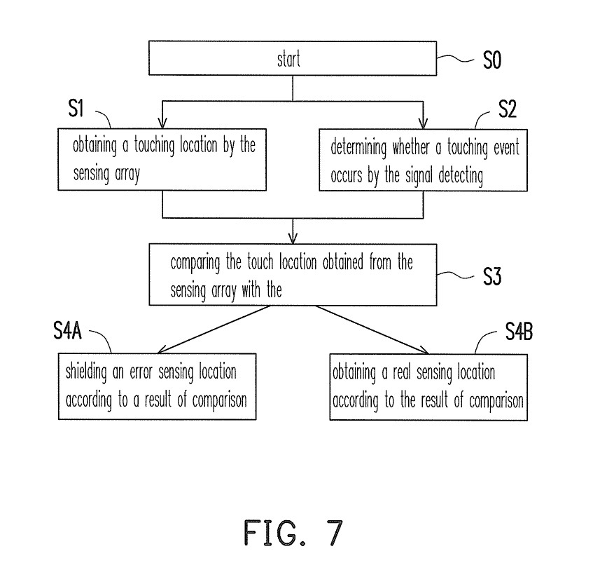

FIG. 7 shows flowcharts illustrating a detecting method for multiple-touching applied to the touch panels of the present invention. Referring to FIG. 7, step S1 obtains a touching location by the sensing array, step S2 determines whether a touching event occurs by the signal detecting units of the signal detecting layer. The step S1 and the step S2 are independent, wherein the step S1 can be performed prior to the step S2, or the step S2 can be performed prior to the step S1, or the step S1 and the step S2 can be performed synchronously. More specifically, following the start step S0, the step S1 is performed to obtain a touching location according to a variation of capacitance of the sensing pads 222 in the sensing array 220. Then, the step S2 is performed to determine whether a touching event occurs by the signal detecting units 232 of the signal detecting layer 230 according to a variation of electric field due to the touching event. Next, the step S3 is performed to compare the touch location obtained from the sensing array 220 with the determination result from the signal detecting layer 230. Particularly, the detecting method for multiple-touching may further comprise performing a step S4A to shield an error sensing location (i.e. the ghost point) according to a result of comparison. Otherwise, the detecting method for multiple-touching may further comprise performing a step S4B to obtain a real sensing location according to the result of comparison. It should be noted that the sequence of the steps S1 and S2 can be reversed.

In summary, the present invention provides a touch panel, a detecting method for multiple touching applied to the touch panel and a touch display apparatus, wherein a signal detecting layer comprising plural signal detecting units is provided to detect the variation of electric field due to a touching event, and thereby the real touch location can be determined. Accordingly, the ghost point produced by multiple-touching on the touch panel can be eliminated, which facilitates an accurate evaluation of the real touch location and improve the precision of locating the touch location on the touch panel.

Although the invention has been described with reference to the above embodiments, it is apparent to one of the ordinary skill in the art that modifications to the described embodiments may be made without departing from the spirit of the invention. Accordingly, the scope of the invention will be defined by the attached claims not by the above detailed descriptions.

What is claimed is:

1. A touch panel, comprising:
a substrate;
a sensing array disposed over the substrate, wherein the sensing array comprises a plurality of sensing pads arranged in array, the sensing pads comprising:
a plurality of first sensing pads arranged along a first direction;
a plurality of second sensing pads arranged along a second direction,
wherein the first direction intersects the second direction; and
a signal detecting layer interlaid between the sensing array and the substrate, wherein the signal detecting layer comprises a plurality of individual signal detecting units, and each of the signal detecting units is corresponding to more than one sensing pads for detecting a variation of electric field due to a touching event.

2. The touch panel as claimed in claim 1, further comprising a plurality of signal detecting wires, wherein each of the signal detecting wires is electrically connected to its corresponding signal detecting unit.

3. The touch panel as claimed in claim 1, wherein the sensing array further comprises:
a plurality of first bridge wires, each of the first bridge wires serially connects two adjacent first sensing pads to form a first sensing series; and
a plurality of second bridge wires, each of the second bridge wires serially connects two adjacent second sensing pads to form a second sensing series.

4. The touch panel as claimed in claim 3, wherein the first sensing pads, the second sensing pads and the second bridge wires are formed by a same transparent conductive layer, while the first bridge wires are formed by another conductive layer.

5. The touch panel as claimed in claim 3, wherein the first sensing pads, the second sensing pads and the first bridge wires are formed by a same transparent conductive layer, while the second bridge wires are formed by another conductive layer.

6. The touch panel as claimed in claim 1, wherein each of the signal detecting units is shaped in substantially a block, and an outline of each of the signal detecting units is aligned with the edge of its corresponding sensing pads.

7. The touch panel as claimed in claim 1, wherein each of the signal detecting units is shaped in substantially a stripe, the signal detecting units are parallel to one another and each of signal detecting units is arranged along a third direction different from the first direction and the second direction, and an outline of each of the signal detecting units is aligned with the edge of its corresponding sensing pads.

8. The touch panel as claimed in claim 1, wherein each of the signal detecting units comprises a plurality of signal detecting pads, each of the signal detecting pads is corresponding to one of the sensing pads, each of the signal detecting pads has an opening in a size substantially equal to a size of each of the sensing pads, and the signal detecting pads coincide with clearances between the sensing pads.

9. The touch panel as claimed in claim 1, wherein each of the signal detecting units comprises a plurality of signal detecting pads, each of the signal detecting pads is corresponding to one of the sensing pads, each of the signal detecting pads is intact, and a size of each of the signal detecting pads is substantially equal to a size of each of the sensing pads.

10. The touch panel as claimed in claim 1, further comprising a controller electrically connected to the signal detecting wires, wherein the variation of electric field due to the touching event detected by the signal detecting units is transmitted to the controller to determine whether a touch event occurs.

11. The touch panel as claimed in claim 1, further comprising a dielectric layer interlaid between the sensing array and the signal detecting layer.

12. The touch panel as claimed in claim 1, further comprising a display panel, wherein the substrate is located on the display panel, and the signal detecting layer is located between the display panel and the sensing array.

13. A detecting method for multiple-touching applied in the touch panel as claimed in claim 1, the detecting method comprising:
obtaining a touching location according to a variation of capacitance of the sensing pads in the sensing array;
determining whether a touching event occurs by the signal detecting units of the signal detecting layer according to a variation of electric field due to a touching event; and
comparing the touch location obtained from the sensing array with the determination from the signal detecting layer.

14. The detecting method as claimed in claim 13, further comprising shielding an error sensing location according to a result of comparison.

15. The detecting method as claimed in claim 13, further comprising obtaining a real sensing location according to a result of comparison.

16. A touch display apparatus, comprising:
a touch panel, comprising:
a substrate;
a sensing array disposed over the substrate, wherein the sensing array comprises a plurality of sensing pads arranged in array, the sensing pads comprising:
a plurality of first sensing pads arranged along a first direction;
a plurality of second sensing pads arranged along a second direction,
wherein the first direction intersects the second direction; and
a signal detecting layer interlaid between the sensing array and the substrate, wherein the signal detecting layer comprises a plurality of individual signal detecting units, and each of the signal detecting units is corresponding to more than one sensing pads for detecting variation of electric field due to a touching event; and
a display panel disposed relative to the touch panel, wherein the signal detecting layer is located between the display panel and the sensing array.
